(19) United States
(12) Patent Application Publication
(10) Pub. No.: US 2007/0186083 A1
(43) Pub. Date: Aug. 9, 2007

(54) Pipelined processor and instruction loop execution method

(76) Inventor: Ferdinand Gustaaf Christiaan Vermeire, Utrecht (NL)

Correspondence Address: MEREDITH & KEYHANI, PLLC, 330 MADISON AVE., 6TH FLOOR, NEW YORK, NY, 10017, US

(21) Appl. No.: 10/994,032

(22) Filed: Nov. 17, 2004

Related U.S. Application Data
(63) Continuation of application No. 10/783,398, filed on Feb. 20, 2004, now abandoned.

(30) Foreign Application Priority Data
Aug. 22, 2001 (EP) EP 01203165.4
Aug. 22, 2002 (NL) PCT/NL02/00556

(51) Int. Cl. G06F 9/44

(52) U.S. Cl. 712/241

(57) ABSTRACT

Processor (10) having a processing pipeline (100) is extended with an arrangement to reduce the loss of cycles associated with loop execution in pipeline (100). Loop start detection until (116a) detects a loop start instruction containing information about the loop count and last instruction in the loop information about the first instruction in the loop is also present. Loop end detection until (114a) is provided with the loop end information, and fetch stage (112) is provided with the loop start information by loop start detection until (116a). Upon detection of a loop end, loop end detection until (114a) generates detection tags labeling the content of pipeline (100) which are evaluated by tag detection until (144). Loop execution control stage (142) compares the loop count information with detection information generated by tag detection until (144) and, if necessary, removes superfluous instructions from pipeline (100).

The invention relates to a processor having a processing pipeline, the processor comprising:

loop end detection means for detecting a loop end to generate detection information; and

a control stage for controlling a loop execution dependent on the detection information.

The invention further relates to a method of executing instruction loops in a pipelined processor, the method comprising the following steps:

detecting a loop end to generate detection information; and

controlling a loop execution dependent on the detection information.

An embodiment of such a processor is known from U.S. Pat. No. 6,003,128. Within the art of processor design, high processor performance is one of the most challenging aspects of this discipline. Inter alia, processor performance can be improved by introducing parallelism into the design, i.e. the performance of more than one processor task within a single operational period e.g. a clock cycle. By increasing the number of processor tasks that can be performed within a single operational period, a high processor performance can be achieved. To facilitate the performance of a number of tasks within a single operational period, a processing pipeline can be included in the processor architecture. In a pipeline, several tasks can be performed at the same time in different pipeline stages, e.g. fetching, decoding and executing of instructions. Typically, a pipeline stage performs a task enabling a next pipeline stage to perform a task in a next clock cycle.

One of the complications in pipelined processing occurs when the execution of ail instruction in an execution stage introduces a disruption of the pipeline flow. When this happens, both the fetch stages and decode stages no longer contain appropriate instructions. In such cases, cycles will be lost because these superfluous instructions have to be removed from the fetch and the decode stages and the execute stage has to update the program counter with a value corresponding to tie address of the appropriate instruction before normal pipeline operations can be resumed. Obviously, the occurrence of such pipeline flow disruptions has a detrimental effect on processor performance. As a complication, contemporary pipeline architectures exhibit large numbers of different pipeline stages to increase processor performance, making these deep pipelines extremely sensitive to these disruptions. Therefore, a lot of design effort is put into the reduction of the number of cycles lost during operation.

A possible source of cycle loss in pipelined processors originates from the execution of so-called instruction loops. Instruction loops consist of a number of instructions e.g. a loop body that has to be executed in a sequential manner for a number of times e.g. iterations. When the pipeline stage responsible for the loop execution detects that the loop body has reached its final iteration, the instruction flow no longer needs to contain a next loop body when the last loop instruction in the last iteration has been executed, i.e. the instruction flow does not need to branch back to the beginning of the loop. However, the pipeline stages preceding the execute stages already contain superfluous instructions belonging to a next loop body, and have to be flushed from the pipeline resulting in a loss of cycles. This can be especially costly in terms of processor performance when the number of preceding stages is large. The aforementioned prior art discloses a superscalar pipelined microprocessor with an arrangement for reducing the loss of cycles when executing an instruction loop. To this end, the prior art uses dedicated loop end instructions, which can be detected in the instruction flow by a loop detection circuit. Inter alia, the loop end instruction contains an instruction to decrement the loop counter of the control stage controlling the loop execution. The execution of this instruction is monitored and registered in a compare value stored in a reorder buffer. On request, this compare value is provided to a loop prediction unit that compares this value with a counter value that is updated each time the loop detection unit detects a loop end instruction being processed. When the difference between the compare value and the counter value is one, the loop prediction circuit will signal the processor that next loop body to be executed is the last loop body, thus enhancing the quality of the branch prediction and reducing the loss of cycles in the processing pipeline.

It is, however, a disadvantage of the known processor is that other causes of cycle loss associated with loop executions in a pipelined processor are left untreated. In particular, when the loop body is small in comparison to the depth of the pipeline, i.e. there are more pipeline stages than instructions in the loop body, the pipeline may already contain several loop bodies prior to execution of the first loop body. Now, when the number of loop bodies to be executed is smaller than the loop bodies already present in the processing pipeline, the processing pipeline already contains superfluous-instructions before starting loop execution. Since the branch prediction mechanism of the known circuit focuses on detection of the last loop body going into execution, this mechanism cannot prevent the loss of a large number of cycles in this particular case, leading to the unwanted decrease in processor performance. This is a serious drawback, because deep pipelines often have to execute few-iteration loops with loop bodies that are significantly smaller than the number of pipeline stages preceding the loop execution stages.

It is a first object of the present invention to provide a processor of the kind described in the opening paragraph with reduced loss of cycles associated with the processing of loops and in particular relatively small loops.

It is a second object of the invention to provide a method of the kind described in the opening paragraph that reduces the loss of cycles associated with the processing of loops and in particular relatively small loops.

Now, the first object is realized in that the processor further comprises loop start detection unit for detecting a loop start instruction, the loop end detection means being responsive to the loop start detection unit, and the loop start detection unit preceding the control stage in the processing pipeline.

As soon as a loop start instruction is detected in the instruction flow, the loop start detection unit triggers the monitoring the presence of loop ends by the loop end detection means. Typically, the loop start instruction is a dedicated loop execution initialization instruction preceding the first loop body in the instruction stream in a contiguous fashion. This is a significant advantage, since the detection information gathered prior to the loop control stage allows alterations to the contents of the pipeline as soon as the loop is started up, thus reducing the number of cycles lost when the number of loop bodies present in the pipeline already exceeds the number of loop bodies to be executed. As soon as the loop stan instruction is detected, loop end detection means are activated by the loop start detection unit and start looking for an instruction indicating a loop end. This can be a dedicated loop end instruction like the one used in the known processor as well as a generic instruction from the instruction set. In the latter case, the loop start instruction contains loop end identification information, which is fed to the loop end detection means.

It is an advantage if the loop end detection means comprise a loop end detection unit preceding the loop start detection unit in the processing pipeline for detecting a loop end to generate a detection tag and a tag detection unit for detecting the detection tag to provide the detection information to the control stage.

By dividing the tasks of the loop end detection means between a loop end detection unit and a tag detection unit, parallelism is introduced in the multitasking of the loop end detection means, thus providing an increase in its performance. The loop end detection unit only has to compare an instruction in the first pipeline stage with a predefined pattern and to generate a detection tag when a loop end is detected. This detection tag can be directly detected by the tag detection unit, which tracks and evaluates the received detection tags.

It is another advantage if the detection tag comprises a first bit indicating a first loop end and a second bit indicating a second loop end. By enabling the detection of different loop ends, cycle loss can also be reduced when small nested loops are encountered. For instance, the first loop end is the loop end of the outer loop, whereas the second loop end is the loop end of the inner loop, but obviously deeper nesting levels are also possible. The presence of this information in the detection tag allows for easy interpretation of the detection tag by the tag detection unit.

It is yet another advantage if the processor further comprises storage means for storing the detection tag.

Even though it is possible to directly transfer the detection tags from the loop end detection unit to the tag detection unit, the architecture of the tag detection unit can become complex when a large number of detection tags are received before the control unit requests the detection information from the tag detection unit, because intermediate results then have to be stored in some form within the tag detection unit. Such design complications can be avoided by the presence of a dedicated storage device for the detection tags, thus allowing the tag detection unit to evaluate all stored detection tags in a single clock cycle.

It is a further advantage if the storage means comprises an additional pipeline at least comprising a first additional pipeline stage corresponding with a first intermediate stage of the processing pipeline and a second additional pipeline stage corresponding with a second intermediate stage of the processing pipeline.

By the presence of an additional pipeline that is operable as a template of the processing pipeline, e.g. the detection tag resides in a pipeline stage of the additional pipeline corresponding with the location of the loop end in the processing pipeline, the tag detection unit not only can retrieve information about the number of loop ends in the processing pipeline but also about the exact location of each of the loop ends in the processing pipeline. This information can be passed on to the control unit, which can accurately flush pipeline cycles based on this information.

Advantageously, the processing pipeline further comprises a fetch unit being responsive to the loop end detection means, said fetch unit comprising further storage means for storing loop instruction information; and a program counter coupled to the further storage means.

By the addition of such functionality to a fetch unit of the processing-pipeline, loop bodies can rapidly be inserted into the processing pipeline, thus enhancing processor performance. Upon the detection of a loop start instruction by the loop start detection unit, the fetch unit is provided with a second data element e.g. the address of an instruction at the beginning of the loop. When the loop end detection means detect an instruction at the end of a loop, the loop end detection means trigger the fetch unit to update the program counter corresponding with the instruction at the start of the loop. This way, loop bodies can be speculatively iterated into the pipeline before execution of the loop.

It is another advantage if the processor further comprises control circuitry responsive to the control stage for manipulating a stage of the processing pipeline. Upon receipt of the loop start instruction and the detection information from the loop start detection unit, the control stage at loop execution start-up, already has been provided with the information which pipeline stages, if any, contain superfluous instructions. By the presence of control circuitry responsive to the control stage, the control stage directly signals which pipeline stages have to be flushed and which first non-loop instruction needs to be fetched, thus already updating the pipeline before the first instruction of the first loop body iteration is executed. This provides a highly efficient processing pipeline in terms of cycles lost. In addition, the control circuitry can also be arranged to deactivate first and loop start detection unit as well as the comparator in tile aforementioned fetch unit.

It is a further advantage if the control circuitry comprises an interrupt handler. Instruction flow disruptions in pipelined processors are often caused by interrupts, because an interrupt usually requires the start up of a new instruction flow. Many pipelined processors are equipped with a dedicated interrupt handler, which is dedicated to switching processor tasks as quickly and as smoothly as possible. Designating a pipeline stage modification request by the control stage as an interrupt, i.e. making the interrupt handler responsive to the control stage, enables the reuse of control circuitry that is already present in the processor architecture, which limits the amount required dedicated hardware.

It is also an advantage if the processor further comprises further control circuitry responsive to the loop end detection means for forcing an instruction into the processing pipeline.

In situations where the number of instructions in a loop body is even smaller than the number of stages preceding the loop end detection means in the processing pipeline, the pipeline already contains superfluous instructions in some of these preceding stages at the beginning of the pipeline. However, the appropriate instructions are also present in some other preceding stages nearer to the loop end detection means. The extension of the processor with further control circuitry responsive to the loop end detection means enables the appropriate instructions to be captured and the superfluous instructions to be replaced with the captured appropriate instructions. This way, the loss of cycles is even further reduced.

It is yet another advantage if the processor comprises a further pipeline at least comprising a first further stage corresponding with a first stage of the processing pipeline and a second further stage corresponding with a second stage of the processing pipeline. The presence of a pipeline in the processor parallel to the processing pipeline, information about the instructions in the processing pipeline like address information in the form of a value of the fetch unit program counter can still be available in the deeper stages of the pipeline. As a result, pipeline flow control instructions like the retrieval of the program counter value of the first instruction in a loop by the loop end detection means can be easily implemented and enabled.

Now, the second object of the invention is realized in that the method further comprises a step of detecting a loop start instruction, the step of detecting a loop end being responsive to the step of detecting a loop start instruction, both steps of detecting a loop end and detecting a loop start instruction taking place before controlling a loop execution.

The invention is described in more detail and by way of non-limiting examples with reference to the accompanying drawings, wherein:

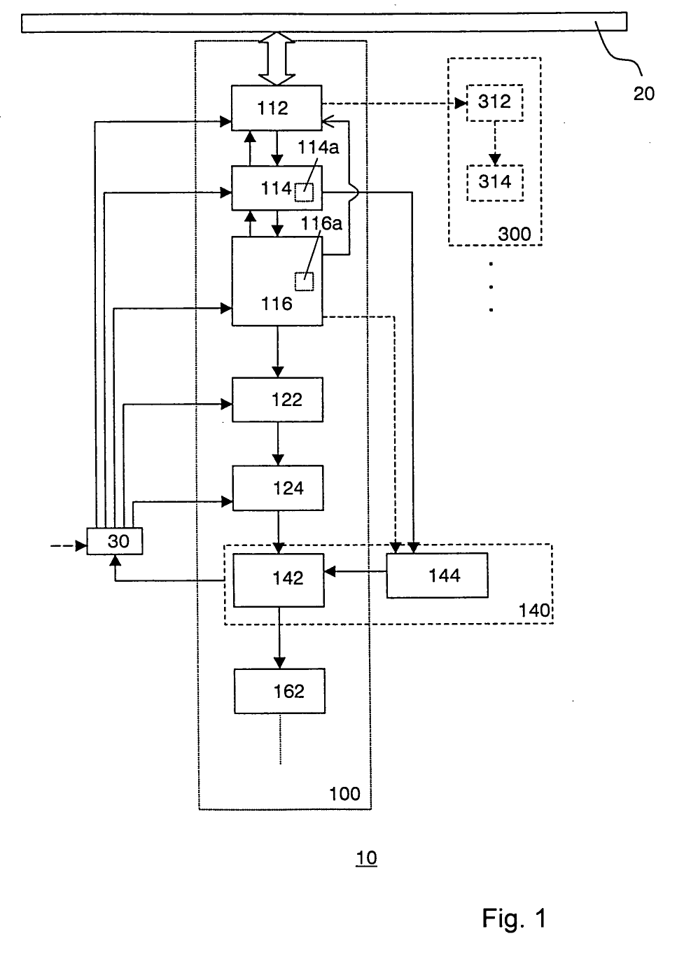

FIG. 1 shows the processor according to an embodiment of the present invention,

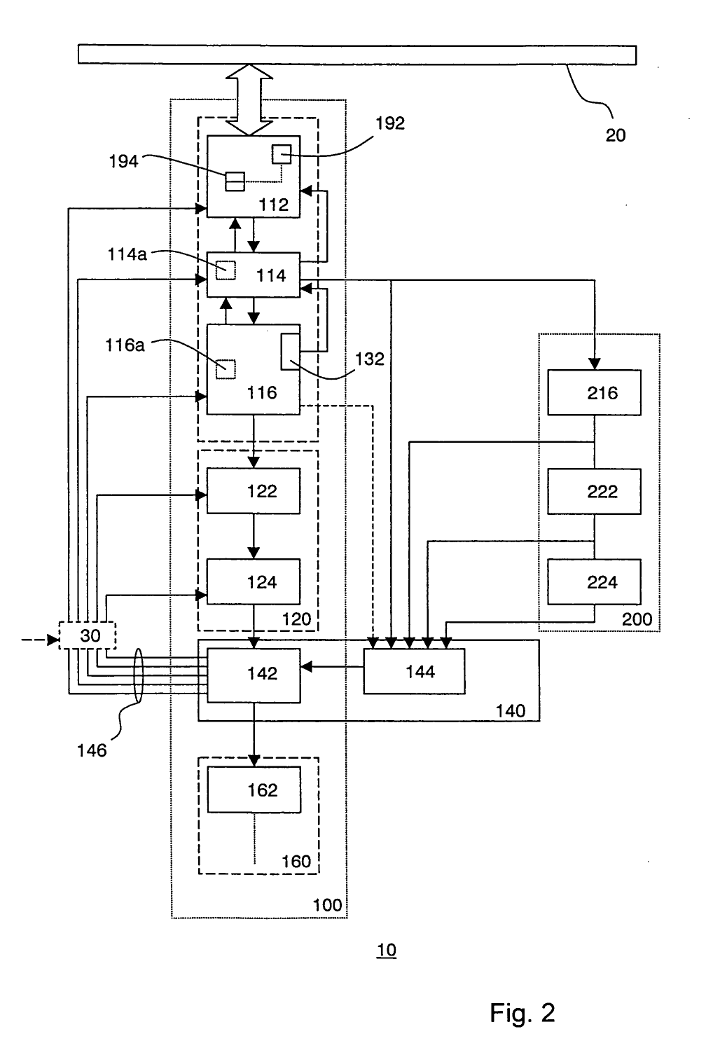

FIG. 2 shows the processor according to another embodiment of the present invention,

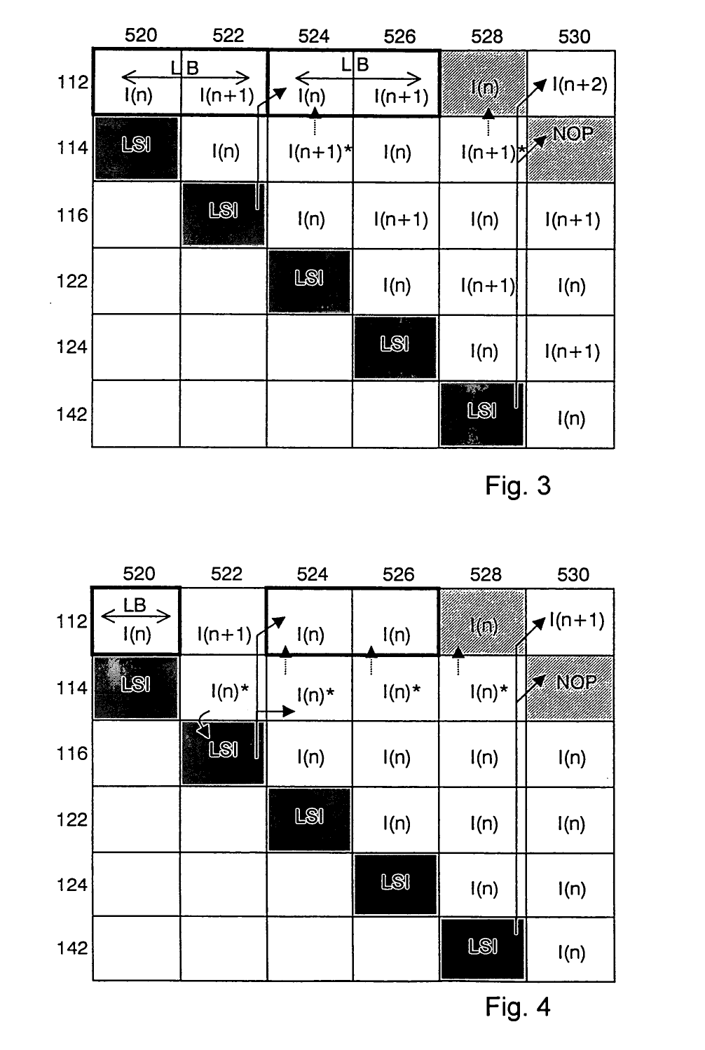

FIG. 3 shows an instruction flow of a loop execution according to the present invention; and

FIG. 4 shows an instruction flow of another loop execution according to the present invention.

In the following description, if an element of the pipeline is referred to a stage without the use of any additional classification both its function as well as its location in the pipeline is unspecified. In addition, although the phrase stage will be used, it will be obvious to those skilled in the art that this can also refer to a microstage or a similar pipeline building block.

In FIG. 1, a processor 10 is shown, and in particular a deep processing pipeline 100 including a fetch stage 112 and stages 114, 116, 122, 124, 142 and 162, in which stage 116 is extended with loop start detection unit 116a and stage 114 is extended with loop end detection unit 114a. The pipeline is father extended with a loop controller 140 having a control stage 142 and a tag detection unit 144. It is emphasized that the arrangement of processing pipeline 100 is chosen as an example; may other pipeline configurations with a different number of stages and a different location of both loop start detection unit 116a and loop end detection unit 114a can be thought of without departing from the scope of the invention. Typically, processing pipeline 100 is also coupled to data bus 20 for communication with other devices like an instruction register not shown and a data register not shown. In deep pipelines, the fetch, decode and execute tasks are typically divided over a number of stages rather then each task being assigned to a single stage in a three-stage pipeline. In the configuration shown in FIG. 1, processing pipeline may have a fetch task shared by fetch stage 112 and stage 114, whereas the decode task may he partitioned over stages 116, 122 and 124. Stages 142 and 162 may be the first execute stages, although other parationings with a different number of stages for each task can be equally feasible. Typically, an execute stage like control unit 142 will be connected to a device like an interrupt handler 30, which, amongst other things, is capable of modifying the content of the pipeline stages 112, 114, 116, 122 and 124.

Loop start detection unit 116a monitors the instruction flow through processing pipeline 100 to detect the presence of a loop start instruction in the instruction flow. Loop start detection unit 116a can detect the presence of the loop start instruction by comparing a part of the instruction opcode with a bit pattern stored in a dedicated register or similar storage device. Therefore, loop start detection unit 116a typically has an n-bit comparator, with n being a positive integer. Preferably, the loop start instruction is a dedicated single instruction preceding the loop body of a loop, e.g. the instructions that have to be repeated a number of times as specified by a value of a loop counter. It is emphasized that, preferably, the loop start instruction is not a part of the loop body, and occurs only once in the instruction flow, which limits the loop control overhead to a single instruction. In an alternative arrangement, the loop start instruction can also be detected by evaluation of the instruction information in the appropriate farther stage of a further pipeline 300, if present.

Optional further pipeline 300 is coupled to processing pipeline 100, which can be used to ripple information about the instructions in processing pipeline 100 synchronized to the rippling of instructions through processing pipeline 100. For instance, on receipt of a first instruction in first stage 112, first stage 112 can output the value of its program counter to first further stage 312. When first stage 112 outputs the fetched instruction to second stage 114, at the same time first further stage 3 12 outputs the received value of the program counter to second further stage 314. This way, information about the instructions, e.g. its instruction register address, in each stage of the processing pipeline 100 can be retrieved from an appropriate stage in further pipeline 300.

An important aspect of the present invention is that, apart from loop initialization information, the loop start instruction also contains information about the last instruction in the loop body. This information, which can be a part of the instruction opcode or an instruction register address of that instruction, is transferred from loop start detection unit 116a to the loop end detection unit 114a. Loop end detection unit 114a typically has an n-bit comparator, a dedicated register and a multiple-bit pattern generator to generate a detection tag upon detection of a last instruction in a loop body. Loop end detection unit 114a is activated by loop start detection unit 116a upon detection of a loop start instruction and, once activated, loop end detection unit 114a will compare the instructions received by stage 114 or the instruction information in second further stage 314 of the farther pipeline 300 with the information about the last instruction in the loop body. As soon as-the last instruction of a loop body is detected by loop end detection unit 114, a multiple-bit detection tag will be generated and outputted to tag detection unit 144. The multiple-bit nature of the detection tag is advantageous, because it allows for the detection of last instructions belonging to different loop bodies, which facilitates the detection of loop end instructions of nested loops. For example, a valid 4-bit detection tag will contain a single one and three zeros. The detection tag ‘1000’, i.e. the first bit of the tag is a logic 1, signals the detection of the last instruction of a loop body of a first loop, e.g. the outer loop ‘0100’, i.e. the second bit of the tag is a logic 1 signals the detection of the last instruction of a loop body of a second loop, e.g. a first loop nested inside the outer loop ‘0010’ signals the detection of a last instruction of a loop nested in the first nested loop and so on. It will be obvious to anyone moderately skilled in the art that other bit patterns with different lengths and formats can be used without departing from the scope of the present invention. Tag detection unit 144 is activated by loop start detection unit 116a upon receipt of a loop start instruction by the latter. In an embodiment of the present invention, tag detection unit 144 stores the received detection tag in a dedicated storage device, e.g. a register, a stack or an equivalent thereof. The order in which these tags are stored is very important, because, similar to the function of further pipeline 300, these tags contain information about the contents of a subset of pipeline stages. Typically, this subset will include all stages from stage 114 containing the loop end detection unit 114a up to control stage 142, where the startup of the loop will be controlled. It is emphasized that even though tag detection unit 144 is shown as an element of loop controller 140, it can also be placed outside the loop controller or integrated in control stage 142 without departing from the scope of the invention. To be able to retrieve the detection tag information, it is essential that a relationship between the order in which the detection tags are stored within tag detection unit 144 and the order of the instructions in the subset of pipeline stages is known. Tag detection unit 144 has an evaluator for evaluating the bit patterns. If a logic 1 is detected at the appropriate bit position in a detection tag, control stage 142 will be notified by tag detection unit 144 that an instruction marking the end of a loop body is detected in one of the stages belonging to the subset of stages of processing pipeline 100. Every time a loop start instruction is detected by loop start detection unit 116a, both low end detection unit 114a and tag detection unit 144 are notified. As a result, loop end detection unit 114a alters the bit position to which the logic 1 in the detection tag is written and tag detection unit 144 starts monitoring this new bit position in the detection tag. As soon as a loop execution is completed under control of loop controller 140, control stage 142 signals loop start detection unit 116a that loop execution has terminated. Loop start detection unit 116a passes this information on to loop end detection unit 114a and tag detection unit 144, which both alter the respective generation and evaluation of the bit tags accordingly. In an alternative arrangement, loop end detection unit 114a and tag detection unit 144 are signaled by control stage 142 instead of loop start detection unit 116a when a loop execution has terminated.

In addition, the aforementioned labeling of a last instruction in a loop body is combined with the utilization of information about the first instruction of a loop body to facilitate speculative iteration of loop bodies in the processing pipeline 100 prior to loop execution. The loop instruction information about the first instruction of a loop body can be included in the loop start instruction in the form of an instruction register address or an offset relative to the last instruction in the loop body to define the loop size. Alternatively, if the loop start instruction precedes the first instruction of the first loop body to be executed, this information can be omitted from the loop start instruction when a further pipeline 300 is present. Now, when the loop start instruction resides in stage 116, the first instruction of the loop body resides in stage 114 at the same time. When the content of the various pipeline stages is rippled to the next stage, stage 116 will receive the first instruction of the loop body from stage 114. Loop start detection unit 116a extracts the loop instruction information e.g. a value of the program counter from the corresponding stage in the further pipeline 300 and transfers this loop instruction information to fetch stage 112 where it is stored in a register 194 or an equivalent thereof. Alternatively, loop start detection unit can extract the loop instruction information from the stage in the further pipeline corresponding with stage 114 before the rippling takes place.

In an embodiment of the invention, loop start detection unit 116a has a storage device e.g. a dedicated register, stack or an equivalent thereof to, store the loop instruction information. In addition, loop start detection unit is coupled to fetch stage 112 for having access to the program counter of the fetch stage 112. Upon detection of an instruction at the end of the loop by loop end detection unit 114a, loop end detection unit 114a signals loop start detection unit 116a, which triggers loop start detection unit 116a to replace the current value of the program counter in fetch stage 112 with the value corresponding to the first instruction of the loop body. Consequently, fetch stage 112 fetches the first instruction of the loop body instead of the instruction that succeeds the last the loop body in the instruction register. This way, loop bodies are speculatively inserted into the pipeline without loss of cycles, as will be explained in more detail later. It is emphasized that the speculative iteration of loop bodies is especially useful for loops with variable loop counters, because variable loop counters become available in a deep stage of the pipeline e.g. control stage 142 rather than being encoded explicitly in the loop start instruction. The speculative iteration of nested loops, i.e. the repetitive loading of loop bodies in the pipeline prior to loop execution, is also possible. The mechanism is basically the same as that explained previously for the generation of multiple bit detection tags. Each time loop start detection unit 116a detects a loop start instruction, the actual information about loop start and loop end instructions is added to the appropriate storage devices. This actual information is now used for the speculative iteration. As soon as control stage 142 signals the completion of the execution of the loop, loop start detection unit 116a and loop end detection unit 114a will remove the actual information from their respective storage devices and speculative iteration of the loop enveloping the terminated loop will resume.

Control stage 142 controls the initialization and execution of the loop associated with the loop start instruction. From tag detection unit 144, information is retrieved about the number and location of loop bodies already inserted into the processing pipeline 100. This information is compared with the number of loop body executions to be performed, which is directly or indirectly retrieved from the loop start instruction. This number may be explicitly present in the loop start instruction, but the loop start instruction may, for example, also contain a register address from where control stage can retrieve this information. The combination of the information from tag detection unit 144 and the loop start instruction enables the update of the processing pipeline 100 even before the loop has entered a first execution stage 162 of the processing pipeline 100. Control stage 142 determines which preceding pipeline stages, if any, contain superfluous instructions and transfers the appropriate information interrupt handler 30, which flushes the pipeline stages containing the superfluous instructions and updates the program counter of fetch stage 112 with the address value of the next useful instruction to be fetched.

The alternative embodiment of processor 10 in FIG. 2 is now described referring back to the detailed description of FIG. 1. Reference numerals used in FIG. 1 have corresponding meanings in FIG. 2, unless stated otherwise. In addition, it is emphasized that optional further pipeline 300 is omitted from FIG. 2 for reasons of clarity only. Processor 10 is extended with an additional pipeline 200 serving as a storage device for the detection tags generated by loop end detection means 114a. Here, by way of example only, additional pipeline 200 has a first additional pipeline stage 216, a second additional pipeline stage 222 and a third additional pipeline stage 224. Preferably, first additional pipeline stage 216 corresponds with a first intermediate stage 116 of the processing pipeline, and a second additional pipeline stage 222 corresponds with a second intermediate stage 122 of the pipeline. This way, the same advantage as previously described for further pipeline 300 is achieved; information about the contents of the various stages of the processing pipeline 100 is rippled through additional pipeline 200 in a simultaneous fashion, thus providing information about the nature and location of the instructions in the processing pipeline 100. Additional pipeline 200 is coupled to tag detection unit 144 to enable the detection and the interpretation of the various detection tags in additional pipeline 200 by tag detection unit 144. Obviously, the storage device included in tag detection unit 144 for storing the detection tags in the previous embodiment of processor 10 can now be omitted.

As an alternative to the earlier described storage device for detection unit 116a for storing loop start information enabling the speculative iteration of loop bodies, this storage device can also be located at other useful locations. Here, fetch unit 112 is extended with a storage device 194 e.g. a register, stack or equivalent thereof, for storing the loop start information retrieved by loop start detection unit 116a. Rather then directly updating the program counter 192 of fetch stage 112 each time loop end detection unit 114a detects a loop end, loop start detection unit 116a transfers the loop start information to the storage device 194 upon receipt of the loop start information. Now, when loop end detection unit 114a detects a loop end, fetch stage 112 is signaled and program counter 192, which is coupled to storage device 194, is updated with the appropriate loop start information stored in storage device 194. It will be obvious to anyone skilled in the art that the storage device 194 can also be integrated in stage 114 or at other useful locations without departing from the scope of the invention.

Control circuitry 146 is coupled to control stage 142 for directly or indirectly controlling the update of pipeline stages containing superfluous instructions and/or, for example, for providing loop start detection unit 116a, loop end detection unit 114a, fetch stage 112 and tag detection unit 144 with the necessary control signals to signal the termination of a loop execution. Functionality of interrupt handler 30 can be transferred to control stage 142, extending the latter with functionality to operate as a dedicated interrupt handler in cases where superfluous loop body instructions as a result of speculative iteration are present in the processing pipeline 100. In an extreme case, the complete functionality of interrupt handler 30 can be transferred to control stage 142, in which case interrupt handler 30 can be omitted from the processor 10.

Processor 10 is extended with further control circuitry 132 responsive to loop start detection unit 116a for forcing an instruction in the processing pipeline 100. In cases where the loop body is so small that superfluous instructions are already present at the moment loop start detection unit 116a detects a loop start instruction, further control circuitry is arranged to replace these superfluous instructions by instructions belonging to the loop body. For instance, in the arrangement shown in FIG. 2, when a loop body of a single instruction is loaded in the pipeline, at the time stage 116 contains the loop start instruction, stage 114 already contains a loop end e.g. the only instruction of the loop body. This implies that fetch stage 112 contains an instruction not belonging to the loop body because speculative iteration yet has to be started up. This is repaired in the next cycle; the instruction received by stage 116 e.g. the only instruction of the loop body is copied into stage 114 by further control circuitry 132 under control of loop start detection unit 116a, thus replacing the superfluous instruction rippled into stage 114 from fetch stage 112. It is emphasized that, as an alternative, further control circuitry 132 can be controlled by loop end detection unit 114a. Furthermore, the location of control circuitry 132 in stage 116 has been chosen as an example only. It will be obvious to anyone skilled in the art that, for example, control circuitry 132 can be located in stage 114 instead without departing from the here presented teachings.

In FIG. 3, an example of a speculative iteration of a loop body (LB) containing two instructions in the processing pipeline 100 according to the method of the present invention is shown. In clock cycle 520, Loop Start Instruction (LSI) resides in stage 114 of processing pipeline 100, instruction I(n), being the first instruction of the loop body, resides in fetch stage 112. In clock cycle 522, the step of detecting a loop start instruction takes place in stage 116 by loop start detection unit 116a. Loop start detection unit 116a retrieves the loop end information from the loop start instruction and transfers this to loop end detection unit 114a. In addition, loop start detection unit 116a retrieves the loop body start information and transfers this to the storage device 194 in fetch unit 112, as indicated by the arrow from stage 116 to fetch stage 112. As an alternative, this information can be directly stored in program counter 192 each time a loop end is detected by loop end detection unit 114a. This enables the speculative iteration of loop bodies into processing pipeline 100. In clock cycle 524, the second and last instruction I(n+1) of the loop body is rippled into stage 114 and, as a result, the step of a loop end to generate detection information takes place. Loop end detection unit 114a signals fetch stage 112 that a loop end is detected, as indicated by the arrow from stage 114 to 112 and fetch stage 112 updates program counter 192 with the address value associated with instruction I(n). Furthermore, the detection information, e.g. the detection tag is generated by loop end detection unit 114a as indicated by the asterisk in stage 114. It is stipulated that the step of detecting the loop end is responsive to the step of detecting a loop start instruction. Loop start detection unit 116a enables the detection of the loop end by loop end detection unit 114a, inter alia by transferring loop end detection information to loop end detection unit 114a. In clock cycle 526 no detection of a loop end takes place. In clock cycle 528, however, loop end detection unit 114a detects another loop end and forces fetch stage 112 to update the program counter as indicated by the arrow from stage 114 to fetch stage 112. Furthermore, the detection tag is generated by loop end detection unit 114a, as indicated by the asterisk in stage 114. In the same clock cycle, LSI reaches control stage 142 and the step of controlling a loop execution dependent on the detection information takes place. Control stage 142 evaluates the detection information provided by tag detection unit 144. In this example, the LSI provides control stage 142 with the information that two iterations of the associated loop have to be executed. From detection unit 144, control unit 142 receives information that two loop bodies are already present in the processing pipeline 100, in particular receiving information indicating the presence of a first loop end in stage 122 and a second loop end in stage 114. This information is used to update the processing pipeline 100; since the last useful loop end resides in stage 114, control stage 142 knows that stage 114 will receive a superfluous instruction I(n) in clock cycle 530. This is repaired by replacing the instruction received by stage 114 by a no operation instruction (NOP) in clock cycle 530 and by updating the program counter in fetch stage 112 on the basis of the loop end information present in the LSI. It is foreseen that in particular cases, instead of replacing the superfluous instruction in stage 114 by a NOP, more useful instructions e.g. instructions restoring a processor status can be forced into the pipeline as well. Due to the fact that both steps of detecting a loop end and detecting a loop start instruction take place before controlling a loop execution, a highly efficient speculative iteration scheme enabling the reduction of cycle loss when dealing with loop sizes smaller than the depth of the processing pipeline 100 is achieved.

In FIG. 4, an example of a speculative iteration of a loop body containing a single instruction in the processing pipeline 100 according to the method of the present invention is shown while referring back to the detailed description of FIG. 3. Reference numerals used in FIG. 3 have corresponding meanings in FIG. 4. Due to the fact that the loop body consists of a single instruction only, the processing pipeline already contains a superfluous instruction in fetch stage 112 when the LSI ad loop end are detected in clock cycle 522. As an option, loop end detection unit 114a signals loop start detection unit 116a in clock cycle 522 that a loop end is detected as indicated by the curved arrow between stage 114 and 116. Since stage 116 contains a LSI at the same time, loop start detection unit 116a knows that a loop body containing a single instruction is loaded. As an alternative, the information about the loop body size is present in the LSI, in which case loop the signaling of loop-start detection unit 116a by loop end detection unit 114a is unnecessary and will not take place. Loop start detection unit repairs the processing pipeline 100 by copying the instruction received from stage 114 back into stage 114, thus replacing the superfluous instruction residing in fetch stage 112 in clock cycle 522. Consequently, processing pipeline 100 can continue its task of fetching, decoding and executing instructions in a normal way even though a loop consisting of as single instruction has to be executed. This means that in this particular case loop execution can still be interrupted by an interrupt call, unlike some processors known from the art, where the pipeline has to be frozen to enable single instruction loop execution, rendering them inaccessible by interrupts.

It should be noted-that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A processor (10) having a processing pipeline (100), the processor (10) comprising:
loop end detection means (114a, 144) for detecting a loop end to generate detection information; and
a control stage (142) for controlling a loop execution dependent on the detection information;
characterized by firer comprising:
a loop start detection unit (116a) for detecting a loop start instruction, the loop end detection means (114a, 144) being responsive to the loop start detection unit (116a), and the loop start detection unit (116a) preceding the control stage (142) in the processing pipeline (100).

2. A processor (10) as claimed in claim 1, characterized in that the loop end detection means (114a, 144) comprise:
a loop end detection unit (114a) preceding the loop start detection unit (116a) in the processing pipeline (100) for detecting a loop end to generate a detection tag; and
a tag detection unit (144) for detecting the detection tag to provide the detection information to the control stage (142).

3. A processor (10) as claimed in claim 2, characterized in that the detection tag comprises a first bit indicating a first loop end, and a second bit indicating a second loop end.

4. A processor (10) as claimed in claim 2, characterized by further comprising storage means (200) for storing the detection tag.

5. A processor (10) as claimed in claim 4, characterized in that the storage means (200) comprise an additional pipeline (200) at least comprising a first additional pipeline stage (216) corresponding with a first intermediate stage (116) of the processing pipeline and second additional pipeline stage (222) corresponding with a second intermediate stage 122) of the processing pipeline (100).

6. A processor (10) as claimed in claim 1, characterized in that the processing pipeline (100) comprises a fetch stage (112) responsive to the loop end detection means (114a), said fetch stage (112) comprising:
further storage means (194) for storing loop instruction information; and
a program counter (192) coupled to the further storage means (194).

7. A processor as claimed in claim 1, characterized by fur comprising control circuitry (146) responsive to the control stage (142) for manipulating a stage (112; 114; 116; 122; 124) of the processing pipeline (100).

8. A processor (10) as claimed in claim 7 characterized in that the control circuitry (146) comprises an interrupt handler (30).

9. A processor (10) as claimed in claim 1, characterized by comprising further control circuitry (132) responsive to the loop start detection means (116a) for forcing an instruction into the processing pipeline (100).

10. A processor (10) as claimed in claim 1, characterized by comprising a further pipeline (300) at least comprising a first further stage (312) corresponding with a first stage (112) of the processing pipeline (100), and a second further stage (314) corresponding with a second stage (114) of the processing pipeline (100).

11. A method of executing instruction loops in a processor (10) having a processing pipeline (100), the method comprising the following steps:
detecting a loop end to generate detection information;
controlling a loop execution dependent on the detection information;
characterized by:
detecting a loop start instruction, the step of detecting a loop end being responsive to the step of detecting a loop start instruction, both steps of detecting a loop end and detecting a loop start instruction taking place before controlling a loop execution.
